(19) United States
(12) Patent Application Publication
(10) Pub. No.: US 2026/0194657 A1
(43) Pub. Date: Jul. 9, 2026

(54) RETROREFLECTOR IDENTIFICATION WITH LIDAR

(71) Applicant: VALEO SCHALTER UND SENSOREN GMBH, Bietigheim-Bissingen (DE)

(72) Inventors: Waqas Malik, Troy, MI (US); Mallika Agrawal, Troy, MI (US)

(73) Assignee: VALEO SCHALTER UND SENSOREN GMBH, Bietigheim-Bissingen (DE)

(21) Appl. No.: 19/009,136

(22) Filed: Jan. 3, 2025

(51) Int. Cl. G01S 17/74; G01S 7/48; G01S 7/4865; G01S 17/931

(52) U.S. Cl. CPC G01S 17/74; G01S 7/4802; G01S 7/4865; G01S 17/931

(57) ABSTRACT

A vehicle device includes an emitter, a mirror, a motor, a receiver, a processor, and a non-transient storage medium. The emitter projects incident beams that are reflected, as reflected beams, by object(s) disposed in an external environment. The mirror redirects the incident beams towards the external environment. The motor rotates the mirror to adjust an exit angle of the incident beams. The receiver generates an electrical signal that corresponds to the reflected beams. The processor receives the electrical signal and generates a histogram, stored on the storage medium, that includes a data plot of a series of pulses. Subsequently, the processor generates curves associated with the pulses that bound portions of the histogram. The processor determines area values corresponding to areas of the histogram delimited by the curves. An area table including the area values is generated, and area values exceeding a retroreflector threshold are classified as retroreflector points.

### BACKGROUND

Autonomous and semi-autonomous vehicles utilize various sensors to traverse their environment. The various sensors may include sensors such as optical sensors, ultrasonic sensors, and radar sensors that generate information regarding the location of objects in the environment. However, highly reflective objects may cause difficulties when attempting to map the local environment with optical sensors. Specifically, due to their light scattering properties, highly reflective objects may cause the detection of false positives or the introduction of data artifacts into a signal produced by the optical sensor. Highly reflective objects are also commonly encountered while driving, as roadway signs are typically manufactured including a retroreflective sheeting layer. As a result, it is desirable to mitigate false positives and data artifacts associated with highly reflective objects when operating an autonomous vehicle using one or more optical sensors.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A vehicle device includes an emitter, a mirror, a motor, a receiver, a processor, and a non-transient storage medium. The emitter projects a plurality of incident beams that are reflected, as a plurality of reflected beams, by at least one object disposed in an external environment of the emitter. The mirror redirects the plurality of incident beams towards the external environment. The motor rotates the mirror, thereby adjusting an exit angle of the plurality of incident beams relative to a horizontal axis. The receiver receives the plurality of reflected beams and generates an electrical signal that corresponds to a received strength of the plurality of reflected beams. The processor receives the electrical signal from the receiver and generates a histogram including a time-series data plot of the electrical signal such that the histogram depicts the electrical signal as a series of pulses. Subsequently, the processor generates a plurality of curves that bound portions of the histogram, where each curve is associated with a corresponding pulse of the series of pulses. The processor proceeds to determine, for each curve of the plurality of curves, an area value correlating to an area of the histogram delimited by an associated curve of the plurality of curves, thereby producing a plurality of area values each associated with the corresponding pulse. An area table comprising the plurality of area values is generated by the processor. The processor classifies each of the plurality of area values that exceeds a retroreflector threshold as a retroreflector point, thereby producing retroreflector points. The non-transient storage medium stores the histogram and the retroreflector points.

A method includes projecting a plurality of incident beams with an emitter. The plurality of incident beams are redirected with a mirror towards an external environment of the emitter. The mirror is rotated with a motor to adjust an exit angle of the plurality of incident beams relative to a horizontal axis. The plurality of incident beams are reflected, as a plurality of reflected beams, by at least one object disposed in the external environment. The plurality of reflected beams are received with a receiver. An electrical signal is generated with the receiver, and the electrical signal corresponds to a received strength of the plurality of reflected beams. The electrical signal is received from the receiver with a processor. A histogram is generated with the processor, and the histogram includes a time-series data plot of the electrical signal such that the histogram depicts the electrical signal as a series of pulses. A plurality of curves are generated, and the curves bound portions of the histogram with the processor. Each curve is associated with a corresponding pulse of the series of pulses. The method further includes determining, with the processor and for each curve of the plurality of curves, an area value correlating to an area of the histogram delimited by an associated curve of the plurality of curves, thereby producing a plurality of area values. Each area value is associated with a corresponding pulse. The method additionally includes generating an area table comprising the plurality of area values with the processor. Each of the plurality of area values that exceeds a retroreflector threshold is classified by the processor as a retroreflector point. The histogram and the retroreflector points are stored on a non-transient storage medium.

A system includes an optical sensor and an Electronic Control Unit (ECU). The optical sensor includes an emitter, a mirror, a motor, and a receiver. The emitter projects a plurality of incident beams that are reflected, as a plurality of reflected beams, by at least one object disposed in an external environment of the emitter. The mirror redirects the plurality of incident beams towards the external environment. The motor rotates the mirror, thereby adjusting an exit angle of the plurality of incident beams relative to a horizontal axis. The receiver receives the plurality of reflected beams and generates an electrical signal that corresponds to a received strength of the plurality of reflected beams. The ECU includes a processor and a non-transient storage medium. The processor receives the electrical signal from the receiver and generates a histogram including a time-series data plot of the electrical signal such that the histogram depicts the electrical signal as a series of pulses. Subsequently, the processor generates a plurality of curves that bound portions of the histogram, where each curve is associated with a corresponding pulse of the series of pulses. The processor proceeds to determine, for each curve of the plurality of curves, an area value correlating to an area of the histogram delimited by an associated curve of the plurality of curves, thereby producing a plurality of area values each associated with the corresponding pulse. An area table comprising the plurality of area values is generated by the processor. The processor classifies each of the plurality of area values that exceeds a retroreflector threshold as a retroreflector point, thereby producing retroreflector points. The non-transient storage medium stores the histogram and the retroreflector points.

Any combinations of the various embodiments and implementations disclosed herein can be used in a further embodiment, consistent with the disclosure. Other aspects and advantages of the claimed subject matter will be apparent from the following description and the claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 depicts a vehicle traversing an external environment in accordance with one or more embodiments of the present disclosure.

FIGS. 2A and 2B depict block diagram hardware overviews of a vehicle and an optical sensor, respectively, in accordance with one or more embodiments of the present disclosure.

FIG. 3 depicts a histogram in accordance with one or more embodiments of the present disclosure.

FIGS. 4A-4F depict images captured by an optical sensor in accordance with one or more embodiments of the present disclosure.

FIG. 5 depicts an area image table in accordance with one or more embodiments of the present disclosure.

FIG. 6 depicts a range image table in accordance with one or more embodiments of the present disclosure.

FIG. 7 depicts an ambient light image table in accordance with one or more embodiments of the present disclosure.

FIG. 8 depicts a modified area table in accordance with one or more embodiments of the present disclosure.

FIG. 9 depicts a flowchart of a method for determining blooming points in accordance with one or more embodiments of the present disclosure.

FIG. 10 depicts a flowchart of a method for determining retroreflector points in accordance with one or more embodiments of the present disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention are directed towards an optical sensor that detects and classifies received electrical signals. The electrical signals correspond to Light Detection and Ranging (LiDAR) points captured by the optical sensor in pulses. Classification of the electrical signals involves the identification of retroreflector points and blooming points, among other identification processes. In the context of this application, retroreflector points refer to received electrical signals of the optical sensor having a high intensity correlating to the presence of an object with a highly reflective surface. While blooming points also have a high received intensity, blooming points correspond to data artifacts introduced by the highly reflective object.

The identification and classification of both retroreflector points and blooming points as described herein centers around an evaluation of the “area under the curve” of the received electrical signal. More specifically, the electrical signal is formed of peaks, or pulses, corresponding to the various points discussed above, and the electrical signal is stored in a tabular histogram format. Each pulse is at least partially bounded by a corresponding curve, such that the “area under the curve” corresponds to an area value associated with a particular pulse. Points with an area under the curve value (denoted as an “area value” below) that exceeds a retroreflector threshold are classified as retroreflector points. Retroreflector points having a similar range value and an intensity that is less than a blooming threshold are classified as blooming points.

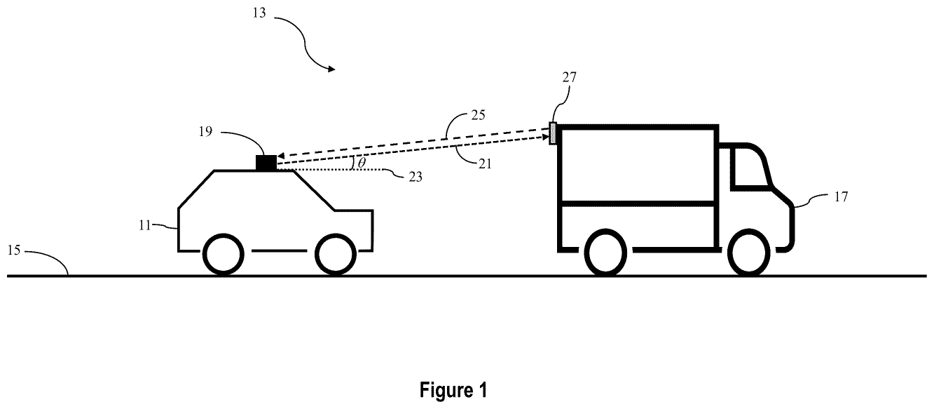

Turning to FIG. 1, FIG. 1 depicts an overview of a vehicle 11 traversing an external environment 13 in accordance with one or more embodiments described herein. The vehicle 11 may be embodied as any vehicle suitable for operating on commercial or private roadways, and may include, but is not limited to, light duty vehicles such as commuter vehicles or heavy duty vehicles such as semi-trucks or construction vehicles. In addition, the vehicle 11 may include an autonomous vehicle, a semi-autonomous vehicle, or a manually driven vehicle that captures LiDAR points as a function of mapping its environment. For example, the vehicle 11 may include a vehicle manually driven through an external environment 13 by a driver, where the vehicle generates a cohesive map of the external environment 13 that is subsequently annotated and utilized in future autonomous driving scenarios.

The vehicle 11 drives on a road 15, which is a paved surface extending through the external environment 13. A truck 17 is also driving on the road 15 in front of the vehicle 11. The particular type of truck 17 may vary, and the truck 17 is provided to demonstrate examples of other automobiles and objects that may be disposed in the external environment 13. For example, the truck 17 may alternatively include a semi-truck, a box truck, a construction vehicle, a passenger car, or any other type of vehicle without departing from the nature of this disclosure.

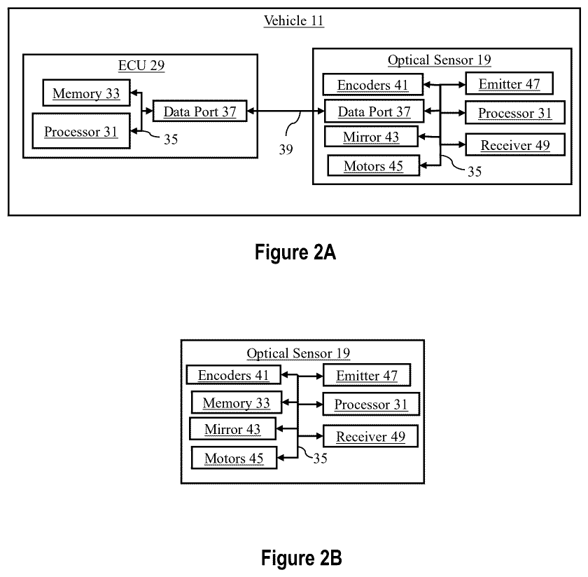

The vehicle 11 includes an optical sensor 19. The hardware of the optical sensor 19 is further discussed in relation to FIGS. 2A and 2B. Briefly, the optical sensor 19 includes an emitter (e.g., FIGS. 2A and 2B) and a receiver (e.g., FIGS. 2A and 2B). The optical sensor 19 may be practically embodied as a LiDAR unit such that the emitter includes at least one Vertical Cavity Surface Emitting Laser (VCSEL) (not shown) that produces light wavelengths in the infrared spectrum. The receiver may be practically embodied as a Single Photon Avalanche Diode (SPAD) array. In one or more alternative embodiments, the emitter may include a laser diode and the receiver may include an Avalanche PhotoDiode (APD) array or photocell array.

The emitter (e.g., FIGS. 2A and 2B) projects lasers as incident beams 21 in to the external environment 13. The incident beams 21 are emitted at an exit angle θ relative to a horizontal axis 23 of the optical sensor 19 that extends substantially parallel to the road 15. Each incident beam is formed as a pulse of light projected into the external environment 13, and the pulses typically have a duration between 2 nanoseconds (ns) and 5 ns. Each incident beam 21 is fully or partially reflected, as a reflected beam 25, by an object in the external environment 13. In the context of FIG. 1, objects include the road 15, the truck 17, and a retroreflector 27. In real world embodiments, it will be appreciated that many types of objects may be present in the external environment 13, such as road signs, pedestrians, features of the road 15 such as curbs, and local flora and fauna.

As discussed above, the retroreflector 27 is formed including a highly reflective surface. Such a highly reflective surface may include, for example, a colored retroreflective sheet formed with glass beads, microprisms, or microlenses. The retroreflective sheet may be a translucent coating applied on the surface of an object, such as an adhesive sheet affixed to a stop sign (not shown). Alternatively, or additionally, the retroreflector 27 may comprise a retroreflective paint layer formed by mixing reflective additives, such as glass powder, with paint prior to painting all or a portion of an object. In general, the term retroreflector broadly relates to objects that reflect or redirect light beams back towards the source (i.e., the optical sensor 19) with minimal scattering such that the light beams are received with a relatively high intensity compared to light beams received from non-retroreflective objects. In the context of FIG. 1, the retroreflector 27 is depicted as a reflective panel attached to the upper rear end of the truck 17.

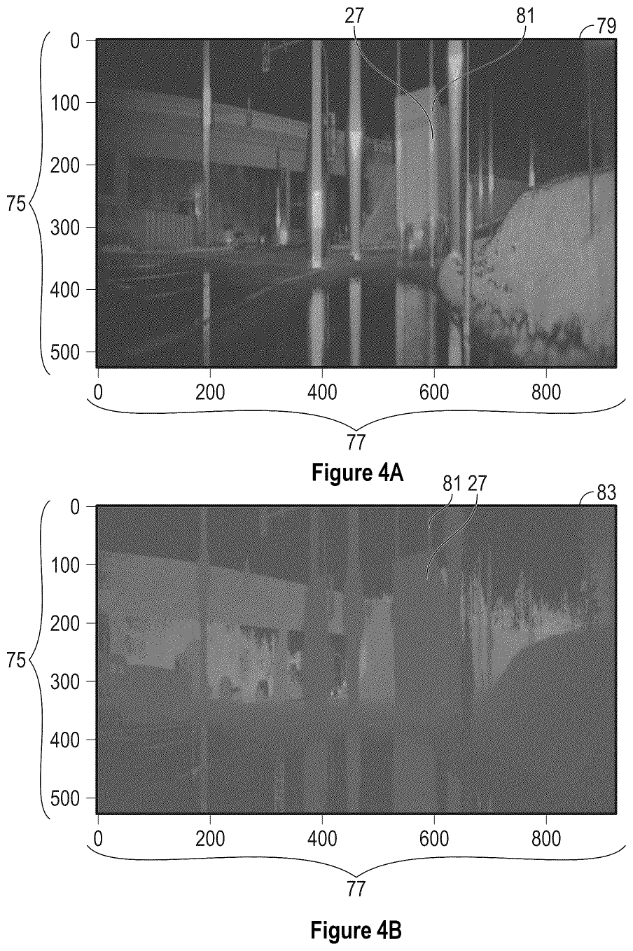

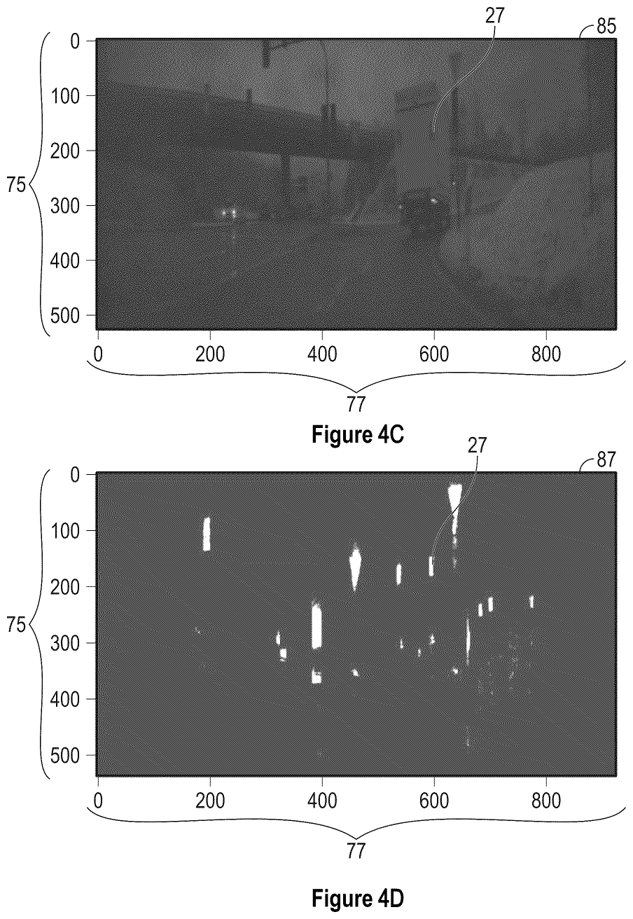

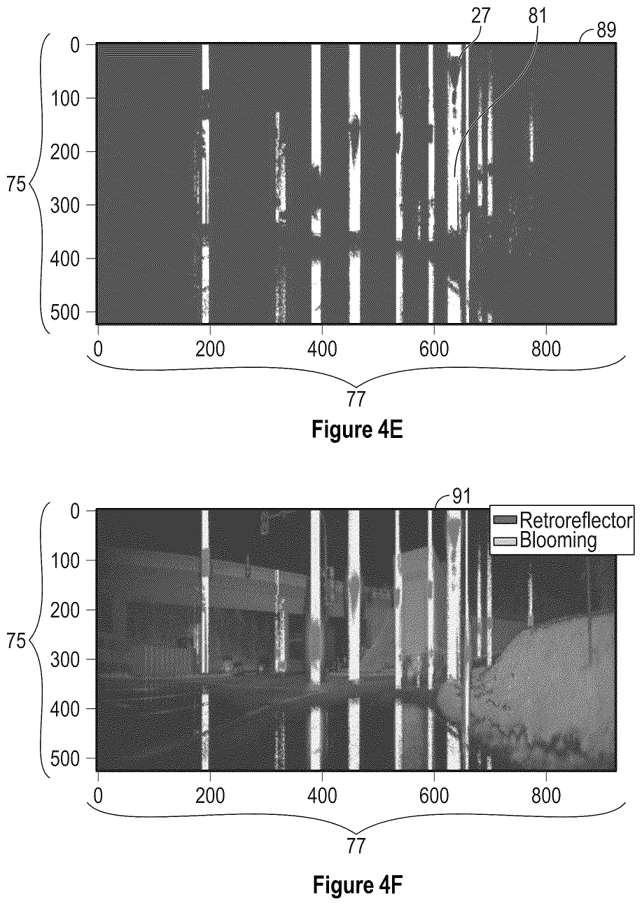

FIG. 1 thus depicts that an incident beam 21 is projected or emitted from the optical sensor 19 and reflected, as a reflected beam 25, by the retroreflector 27 of the truck 17. The optical sensor 19, and more specifically the receiver (e.g., FIGS. 2A and 2B) thereof, detects the received strength of the reflected beam 25 and generates a corresponding electrical signal. Such an electrical signal is processed by the optical sensor 19, or other hardware of the vehicle 11, to determine if a particular object is a retroreflector 27 or blooming (e.g., FIGS. 4A-4F).

Turning to FIGS. 2A and 2B, FIG. 2A depicts a block diagram of hardware forming the vehicle 11 and the optical sensor 19, whereas FIG. 2B depicts an optical sensor 19 embodied as a stand-alone device. FIG. 2A may be practically embodied as a vehicle 11 equipped with a LiDAR unit and utilizing LiDAR data for autonomous driving purposes. FIG. 2B may be practically embodied as a vehicle LiDAR device utilized by a manually driven mapping vehicle. FIG. 2B is also representative of a “plug-and-play” LiDAR unit that may be packaged and sold as an aftermarket part for vehicle 11 upgrades. As yet another example, FIG. 2B may further represent a LiDAR unit of an autonomous vehicle that beneficially reduces LiDAR data processing loads imposed on the remaining computing systems of the vehicle 11.

The vehicle 11 of FIG. 2A includes an Electronic Control Unit (ECU) 29 and an optical sensor 19. The ECU 29 includes a processor 31, a memory 33, a data connection 35, and a data port 37. Overall, the ECU 29 controls various aspects of the vehicle 11 such as combustion timing and power output of the engine and, in the case of autonomous driving, controls the trajectory and speed of the vehicle 11. The various components of the ECU 29 are discussed further below.

The processor 31 includes a microprocessor, a dedicated or integrated circuit, a series of processors, or equivalent device that executes computer readable instructions stored on the memory 33. The processor 31 may be practically embodied as a Central Processing Unit (CPU), and may further include a Graphics Processing Unit (GPU) for parallel processing. The memory 33 comprises a non-transient storage medium such as a Hard Disc Drive (HDD), a Solid State Drive (SSD), or similar data retention devices. The data connection 35 serves to transmit electrical signals between the various components of the ECU 29. The data connection 35 is formed as a data bus and may be embodied as an electrically conductive layer of a printed circuit board, a wire or series of wires, or a combination thereof. The data port 37 forms a data transmission and reception point and may be practically embodied as a plug for a wiring harness, a Universal Serial Bus (USB) port, an ethernet port, or equivalent port types.

A wiring harness 39 serves to connect the data port 37 of the ECU 29 to a data port 37 of the optical sensor 19. The wiring harness 39 may be formed as a bundle of wires and associated connectors at the ends of the bundle. The wiring harness 39 may alternatively also be embodied as an ethernet cable or a USB cable, consistent with embodiments of the data port 37. Data is transmitted via the wiring harness 39 from the optical sensor 19 to the ECU 29 in real-time such that the ECU 29 is apprised of the external environment 13 without substantial processing delays.

The optical sensor 19 of FIG. 2A includes a series of encoders 41, a mirror 43, a motor 45, an emitter 47, a processor 31, and a receiver 49, which are interconnected by way of a data connection 35. The emitter 47 emits a plurality of incident beams 21 and may be practically embodied as a VCSEL as discussed above. The receiver 49 may be embodied as a SPAD array that receives the incident beams 21 as reflected beams 25 as also discussed above. The mirror 43 serves to redirect the incident beams 21 projected by the emitter 47 towards the external environment 13 and may be practically embodied as a tilt mirror. The motors 45 include a first motor that is attached to the mirror 43 and rotates the mirror about a first axis, and a second motor that collectively rotates the mirror 43 and the first motor about a second axis. The motors 45 may practically be embodied as servo motors. The encoders 41 serve to capture the position of the mirror 43 in relation to the first axis and the second axis such that the encoders 41 also serve to measure the degree of actuation of the motors 45. The encoders 41 may be practically embodied as optical encoders or absolute rotary encoders.

In FIG. 2A, the processor 31 of the optical sensor 19 issues control commands to the emitter 47 instructing the emitter 47 to project the incident beams 21 at specified intervals. Data captured by the receiver 49 is transmitted, directly or indirectly, to the processor 31 of the ECU 29 for processing. FIG. 2B presents a compact arrangement of an optical sensor 19 that processes the reflected beams 25 in a single device and packaging.

In FIG. 2B, the optical sensor 19 includes similar components to the hardware of the vehicle 11 as depicted in FIG. 2A. The processor 31 of the optical sensor 19 of FIG. 2B thus performs the functions of controlling the emitter 47 and the functions of processing electrical signals received from the receiver 49. That is, the processor 31 in FIG. 2B performs similar functions to both the processor 31 of the ECU 29 and the processor 31 of the optical sensor 19 in FIG. 2A. The memory 33 serves to store data generated by the processor 31 based upon an electrical signal transmitted from the receiver 49, as well as algorithms for processing said data. Other components of FIG. 2B function substantially similar to the components of the optical sensor 19 of FIG. 2A and have not been further described in the interest of brevity. As noted above, FIG. 2A presents a hardware overview that may be utilized in an autonomous vehicle, for example, whereas FIG. 2B presents a block diagram overview of hardware implemented in a standalone LiDAR unit.

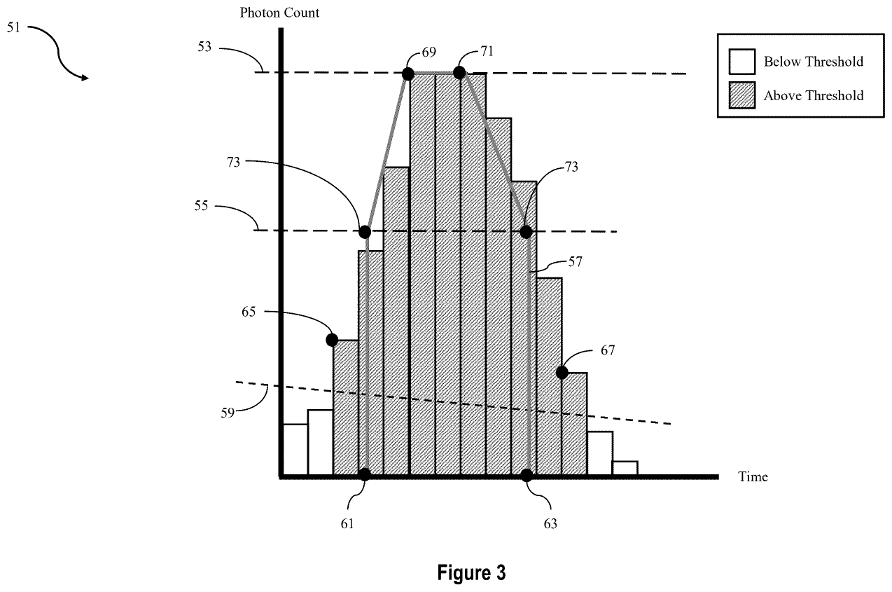

FIG. 3 depicts a histogram 51 in accordance with one or more embodiments described herein. FIG. 3 specifically depicts a small portion of a photon count histogram 51 generated by the processor 31 and corresponding to an electrical signal output by the receiver 49. As noted above, the receiver 49 is embodied as a SPAD array formed with avalanche diodes. The receiver 49 outputs an electrical signal corresponding to the amount of detected photons to the processor 31, and the processor 31 generates the histogram 51 from the received electrical signal. The amount of detected photons substantially corresponds to the strength of the reflected beam 25 as received by the receiver 49, as a higher number of photons corresponds to a brighter or more intense reflected beam 25.

The vertical axis of FIG. 3 denotes the photon count as provided by the electrical signal. The horizontal axis of the histogram 51 denotes the time corresponding to the photon count. The histogram 51 thus depicts the amount of photons detected by the receiver 49 over a period of time. As noted above, the incident beams 21 are projected as pulsed beams (i.e., short bursts) of light, and the reflected beams 25 are thus detected as pulsed beams with a bell shaped photon count. Each of the reflected beams 25 corresponds to a single pulse, and the histogram 51 depicts a pulse having a peak amplitude 53. In real world embodiments, a histogram 51 will encompass a plurality of pulses, and the depiction of a single pulse is not intended to imply that the receiver 49 is only capable of receiving a single pulse.

A curve 57 binds a portion of the pulse, and each pulse is associated with a separate curve 57. The boundaries of the curve 57 are determined based upon the peak amplitude 53 and a retroreflector threshold 59. The retroreflector threshold 59 is determined using a linear Support Vector Machine (SVM) algorithm employing an equation of the following form:

$$( w * x ) + b = 0 \qquad ( 1 )$$

In equation (1), above, “w” represents a weighting vector, “x” represents a feature vector, and “b” is a bias term. In general, the goal of an SVM process is to determine values of w and b that maximize the distance between a hyperplane and the data points (i.e., the photon counts). In the context of this disclosure, the linear SVM algorithm determines a retroreflector threshold 59 that separates the photon counts into two categories; retroreflector points and non-retroreflector points. As shown in FIG. 3, the retroreflector threshold 59 has a negative slope, which is due to the leftmost photon counts being greater than the rightmost photon counts. The first photon count eclipsing the retroreflector threshold 59 is denoted as the first leading edge 65 and the last photon count that eclipses the retroreflector threshold 59 is denoted as the last leading edge 67. The phrase “leading edge” refers to the left hand side of a particular rectangle representing a photon count.

The upper portion of the curve 57 extends along the peak amplitude 53. As discussed in relation to FIG. 1, an incident beam 21 that strikes a retroreflector 27 is reflected with minimal scattering as a reflected beam 25. Such a reflected beam 25 with minimal scattering excites the receiver 49 to its maximum excitation potential. As a result, the peak of the pulse for a reflected beam 25 received from a retroreflector 27 is equal to the peak amplitude 53 capable of being received by the receiver 49. The curve 57 will also have an upper portion that lies on the peak amplitude 53 in order to capture the peak of the pulse and the maximum detected photon count. The curve 57 specifically extends along the peak amplitude 53 from a first leading edge 69 that achieves the peak amplitude 53 to a last leading edge 71 that achieves the peak amplitude 53.

A half amplitude line 55 is also denoted in FIG. 3. The half amplitude line 55 is vertically positioned at a midpoint between the peak amplitude 53 and the y-axis intercept of the retroreflector threshold 59. The half amplitude line 55 aids in determining the Full Width at Half Maximum (FWHM) of the pulse, which is expressed as an FWHM start 61 and an FWHM end 63. The FWHM start 61 forms the left hand side of the curve 57 and the FWHM end 63 forms the right hand side of the curve 57. The FWHM start 61 and the FWHM end 63 each extend in a vertical direction from the horizontal axis to the half amplitude line 55.

The location of the FWHM start 61 and the FWHM end 63 is related to the peak intensity of the pulse. As shown in FIG. 3, the curve 57 includes two sloped portions extending from the peak amplitude 53 to the half amplitude line 55. The sloped portions each pass through the leading edge points of the photon counts between the peak amplitude 53 and the half amplitude line 55. The intersections of the sloped portion of the curve 57 with the half amplitude line 55 are denoted as half amplitude FWHM intersections 73. The FWHM start 61 and the FWHM end 63 vertically extend from the half amplitude line 55 to the horizontal axis, such that the FWHM start 61 and the FWHM end 63 depend on the half amplitude FWHM intersections 73.

The remainder of this disclosure largely focuses on calculating an “area under the curve” value associated with the pulse. The phrase “area under the curve” refers to the area of the curve 57. As shown in FIG. 3, the curve 57 has a shape that may be formed as a trapezoid stacked on a rectangle. The area of the curve 57 may thus be determined by calculating the area of the rectangular portion and the area of the trapezoidal portion using trivial calculations and adding said areas together. In other embodiments, the area under the curve may be found using approximation methods (i.e., a Riemann sum) or using integration methods.

Turning to FIGS. 4A-4F, each of FIGS. 4A-4F depict images generated by the processor 31 using histogram 51 data as depicted in FIG. 3. FIGS. 4A-4F are each composed of layers 75 and slots 77. The term “layer” refers to the a row of image data, whereas the term “slots” refers to a column of image data. Specific image data points thus correspond to a specific layer 75 and slot 77 combination. Each image of FIGS. 4A-4F has 520 layers 75 and 960 slots 77 (i.e., a resolution of 960×520). It will be appreciated that the particular dimensions of the images may vary according to the configuration and structure of the optical sensor 19, and the resolution of the images does not substantially impact the type of information contained thereby.

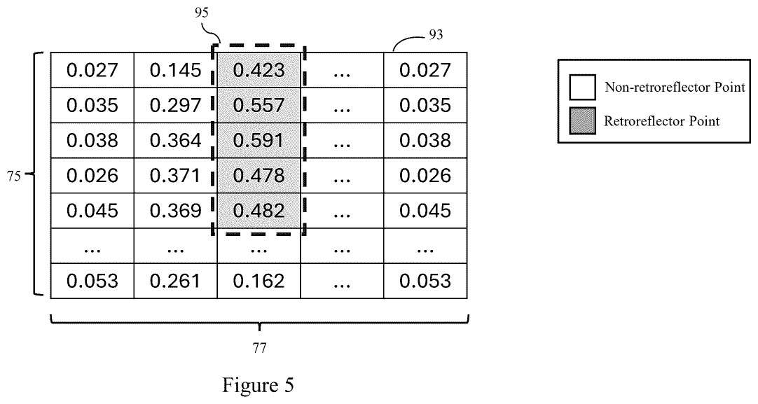

As is also discussed further in relation to FIGS. 5-8, each image depicted in FIGS. 4A-4F may alternatively be represented as a table of data points, allowing for mathematical processes to be employed on the images. For example, instead of being depicted as layers 75 and slot 77 with shades of gray, the intensity image 79 may instead be represented as a table with Red Green Blue (RGB) decimal codes or intensity values, where each cell of the table has a value corresponding to the data contained of the associated image.

FIG. 4A specifically depicts an intensity image 79. Each specific layer 75 and slot 77 combination is depicted as a grayscale shade corresponding to a peak amplitude of an associated pulse as derived from the histogram 51. For example, it can be seen in FIG. 4A that the lower left hand corner of the image is nearly black, and layer 75 and slot 77 combinations in this region have low Red Green Blue (RGB) decimal codes. In juxtaposition, layer 75 and slot 77 combinations associated with reflective objects are much brighter and have a higher RGB decimal code. Such is depicted in FIG. 4A as the retroreflector 27, which has a much brighter shade of gray than the lower left hand corner of the image. Blooming 81 is depicted as a slightly darker shade of gray extending as a band above and below the retroreflector 27. That is, points forming the blooming 81 occupy the same slot(s) 77 as points forming the retroreflector 27.

FIG. 4B depicts a range image 83. Each layer 75 and slot 77 combination of FIG. 4B corresponds to the Time of Flight (ToF) of an associated LiDAR pulse (i.e., an incident beam 21 and a reflected beam 25). In FIG. 4B, brighter shades of grey (i.e., high RGB decimal codes) depict objects further from the optical sensor 19, whereas darker shades of grey correspond to objects closer to the optical sensor 19. Blooming 81 is depicted in FIG. 4B, which is located at the same position at the blooming 81 in FIG. 4A. Although not visibly distinguishable from its surroundings, a retroreflector 27 is denoted in FIG. 4B at the same position as the retroreflector 27 of FIG. 4A. Because the ToF does not influence the intensity of the LiDAR pulse, FIG. 4B also depicts that the range of the blooming 81 is the same as the range of the retroreflector 27. That is, the optical sensor 19 detects the blooming 81 and the retroreflector 27 at the same distance.

FIG. 4C depicts an ambient image 85. The ambient image 85 depicts an amount of ambient (i.e., passive) light present in the external environment 13 of the vehicle 11. The amount of ambient light is detected using a SPAD array such as the receiver 49 as discussed above. As also discussed above, incident beams 21 are emitted as pulses. The ambient light may be captured by the receiver 49 in between pulses of light. Because blooming 81 is an effect of receiving reflected beam(s) 25 from a retroreflector 27, and because the ambient light is captured between pulses of light, the ambient image 85 does not exhibit blooming 81.

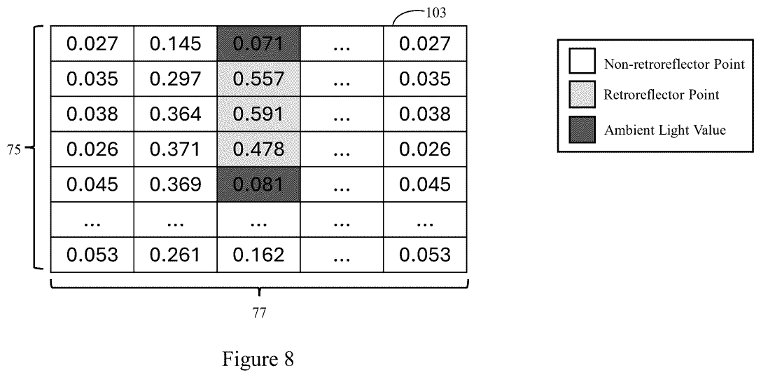

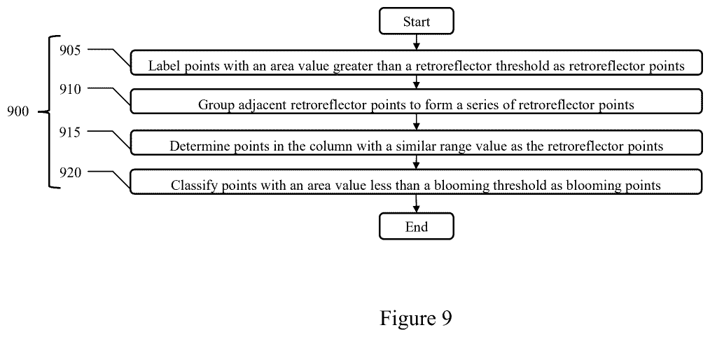

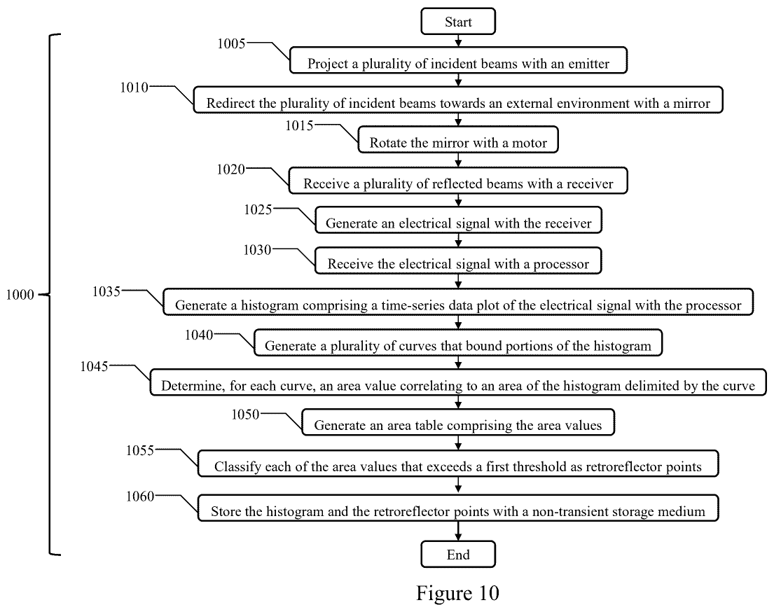

FIG. 4D depicts a retroreflector image 87. The retroreflector image 87 depicts the locations of retroreflectors 27 detected by the optical sensor 19 and/or the ECU 29. The process of detecting retroreflectors 27 is further discussed in relation to FIGS. 9 and 10. As discussed in relation to FIG. 3, retroreflector points are determined by identifying pulses of the histogram 51 that have a peak intensity that eclipses the retroreflector threshold 59. The retroreflector threshold 59 is determined by a linear SVM algorithm. FIG. 4D also depicts that blooming 81 is not included in the retroreflector image 87, such that the points corresponding to blooming 81 have been removed or deleted. The processes for identifying blooming points 81 and removing the blooming 81 from the retroreflector image 87 are discussed in relation to FIGS. 8 and 9, below.

FIG. 4E depicts a blooming image 89. The blooming image 89 denotes the location of the blooming points 81. Each blooming point 81 is located in a slot 77 that also includes a retroreflector 27 point. Such is consistent with FIG. 4A, which also illustrates that blooming points 81 are located in the same slots 77 as the retroreflector 27 points. The retroreflector 27 is illustrated as a silhouette surrounded by blooming points 81 in FIG. 4E. That is, it is to be understood that blooming points 81 are generated by retroreflectors 27, such that any portion of the blooming image 89 that is surrounded (but not formed) by blooming points 81 corresponds to a location of a retroreflector 27.

FIG. 4F depicts an output image 91. The output image 91 includes annotative masks overlaid on identified blooming points 81 and retroreflector 27 points. The masks are superimposed on an intensity image 79 as depicted in FIG. 4A such that the base layer of the output image 91 prior to overlaying masks is substantially similar to the intensity image 79. Such an output image 91 is beneficial for an autonomous vehicle traversing an environment (such as the vehicle 11 in one or more embodiments), as the autonomous vehicle is apprised of whether objects in the external environment 13 are physically present or are merely artifact. In addition, once blooming points 81 are identified and retroreflector 27 points are identified, object detection processes using object boundaries (e.g., semantic object identification and image segmentation processes) may be subsequently performed on the basis of the determined retroreflectors 27. That is, the shape of a particular retroreflector 27 may provide contextual information on the identity of an object (e.g., a retroreflective sign having an octagonal profile, which is unique to stop signs).

Turning to FIGS. 5-8, FIGS. 5-8 each depict examples of tables corresponding to images depicted in FIGS. 4A-4F. FIGS. 5-8 are provided to demonstrate that each of the images of FIGS. 4A-4F may also be represented as a data table containing associated values, allowing for mathematical processes and manipulations to be derived therefrom. The particular values provided in the tables of FIGS. 5-8 are for illustrative purposes only, and are not intended to limit the particular data values generated by an optical sensor 19 or an ECU 29.

FIG. 5 specifically depicts an area image table 93. Each cell of the area image table 93 corresponds to a particular layer 75 and slot 77 combination. The values of the area image table 93 correspond to the value of the area under the curve 57 of the corresponding light pulse (i.e., a reflected beam 25). Although not illustrated for the sake of visual clarity, it will be appreciated that the area image table 93 has the same dimensions as the images of FIGS. 4A-4F (e.g., 520 layers 75 by 960 slots 77). Values of the area image table 93 are expressed in terms of normalized intensity values ranging from zero (no photons detected) to one (full receiver 49 saturation).

The cells of FIG. 5 that have values greater than the retroreflector threshold 59 are shaded, whereas cells that have values less than the retroreflector threshold 59 are not shaded. Such is for illustrative purposes only in order to draw attention to the retroreflector points. Within the area image table 93, a series of retroreflector points 95 are bounded by a dashed box. Each retroreflector point within the series of retroreflector points 95 is adjacent to at least one other cell that is also a retroreflector point, such that the minimum number of retroreflector points needed to form a series of retroreflector points is two retroreflector points. In one or more alternative embodiments, the minimum number of retroreflector points necessary to form a series thereof may include three or more retroreflector points. In the case of FIG. 5, the series of retroreflector points 95 includes five retroreflector points. The underlying motivation for a series of retroreflector points 95 to include multiple adjacent identified retroreflector points is to avoid false retroreflector classifications where a single reflected beam 25 is received with a high intensity. Determining the location (i.e., the indices of layers 75 and slots 77) of a series of retroreflector points 95 forms the first step of identifying blooming points 81 as discussed further below.

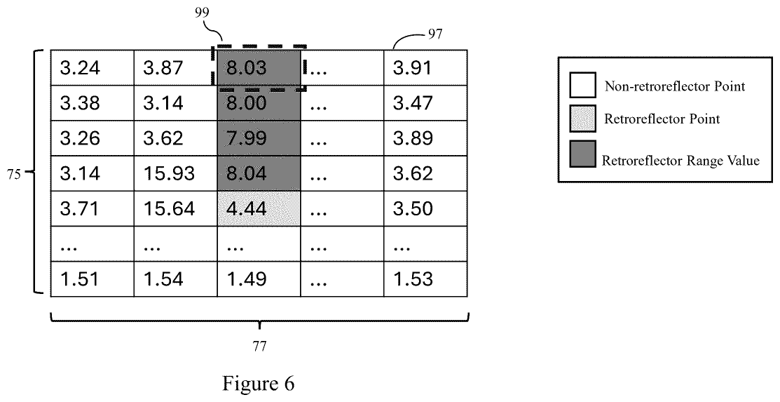

FIG. 6 depicts a range image table 97. The range image table 97 includes range values associated with each received reflected beam 25. The range values may be expressed in units of distance such as meters (m), centimeters (cm), or equivalent measurement units. The cells associated with the series of retroreflector points 95 in FIG. 5 are shaded in FIG. 6 in order to represent that area under the curve values of FIG. 5 and range values of FIG. 6 having the same locations correspond to the same reflected beam 25. For example, the upper cell of the third slot 77 of the range image table 97 has a value of 8.03 and the corresponding cell of the area image table 93 has an area value of 0.423. The cell of the above example thus describes that a particular reflected beam 25 was reflected at a distance of 8.03 m and has an area under the curve value of 0.423 (i.e., moderate intensity).

The range values associated with the series of retroreflector points 95 are subsequently evaluated for similarity. As described herein, the phrase “similarity” in the context of “similar range values” implies values within a predetermined range threshold. The range threshold may be a distance itself, (e.g., all values must be within a threshold distance of 5 centimeters from each other) or a predefined percentage of a distance (e.g., within 5 percent of the maximum distance value of the evaluated range values) of points associated with a retroreflector 27. As discussed above in relation to FIGS. 4D-4F, the blooming points 81 have a similar range to the retroreflector 27 points. Retroreflector points and blooming points 81 associated with the same retroreflector 27 will also have a similar range. Thus, range values of the range image table 97 that are not similar to range values of other identified retroreflector points of the series of retroreflector points 95 are delisted as retroreflector points.

For example, and continuing with FIG. 6, the cell occupying the fifth layer 75 and the third slot 77 has a value of 4.44. Other range values occupying the first layer 75 through the fourth layer 75 of the third slot 77 are within 0.05 meters from each other, such that the remaining values of the series of retroreflector points 95 are all approximately equal to 8.00 meters. Due to the large juxtaposition between the fifth layer 75 value and the remaining values, the fifth layer 75 value of 4.44 is delisted as a potential blooming point 81 or retroreflector 27 point, and is no longer considered to be part of the series of retroreflector points 95.

FIG. 6 further includes a box denoting potential blooming point(s) 99. The process for determining potential blooming point(s) 99 is discussed further in relation to FIG. 9. Briefly, the determination of the blooming point(s) 99 involves comparing the area under the curve values contained in the area image table 93 and associated with the series of retroreflector points 95 (sans any delisted points) to a second threshold, denoted as a “blooming threshold” below. If any of the retroreflector points 95 have area values less than the blooming threshold, the points are reclassified from retroreflector 27 points to blooming points 81.

Continuing with the above, and as can be seen from the area image table 93, each of the area values associated with the retroreflector points 95 are greater than 0.4, and are classified as retroreflector 27 points as a result thereof. A value of 0.4 thus serves as the retroreflector threshold applicable to the evaluated cells and as determined by the linear SVM algorithm. The area image table 93 further depicts that every retroreflector point of the series of retroreflector points 95 has a value greater than 0.43, aside from the uppermost cell of the series (i.e., the cell occupying the first layer 75 and the third slot 77 in both of FIGS. 5 and 6). A value of 0.43 may thus correspond to the blooming threshold, such that the uppermost cell being associated with an area value of 0.423 is reclassified as a potential blooming point 99, despite having a similar range value to the remaining points of the series of retroreflector points 95. The particular values of the retroreflector threshold and the blooming threshold may vary according to numerous design and environmental considerations, and the specific values provided above merely provide one example of potential threshold values.

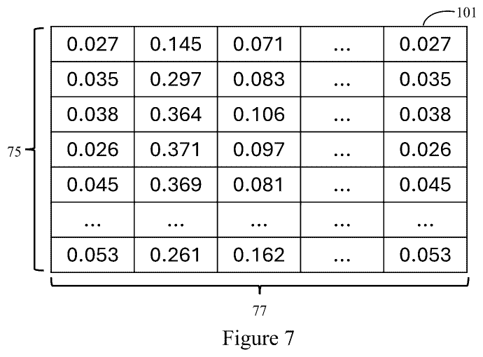

Turning to FIG. 7, FIG. 7 depicts an ambient light image table 101. The ambient light image table 101 stores ambient light values of the external environment external environment 13. The values of the ambient light image table 101 correspond in layer 75 and slot 77 location to the values of the area image table 93 and the range image table 97. That is, each cell of the ambient light image table 101 represents the amount of ambient light received by the receiver 49 at a same location in the field of view of the optical sensor 19 as the reflected beams 25. Values occupying cells of FIG. 7 thus represent photon counts detected without the added strength (i.e., additional photons) of a reflected beam 25. Similar to FIG. 5, values of the ambient light image table 101 are expressed in terms of intensity values ranging from zero (no photons detected) to one (full receiver 49 saturation).

FIG. 8 depicts a modified area table 103. The modified area table 103 is generated by the processor 31 using the values of the area image table 93, the range image table 97, and the ambient light image table 101. Initially, the processor 31 copies the area image table 93 such that the first iteration of the modified area table 103 is the same as the area image table 93. The processor 31 determines blooming points 81 and delisted retroreflector 27 points using processes discussed above. Once the blooming points 81 and delisted retroreflector 27 are identified, the values occupying such cells are replaced with values from the ambient light image table 101. A modified area image (not shown) may be generated using grayscale RGB decimal codes corresponding in position and magnitude to the values of the ambient light image table 101. Such a modified area image (not shown) would substantially correspond to the intensity image 79 of FIG. 4A without blooming 81. An autonomous vehicle that utilizes processes described herein may ultimately be provided with an augmented image without the presence of blooming points 81, which is beneficial for autonomously traversing the environment without the vehicle 11 experiencing visual hallucinations from blooming 81 artifacts.

FIG. 9 depicts a flowchart of a method 900 for determining blooming points 81 and retroreflector 27 points. Steps of the flowchart shown in FIG. 9 may be performed by an optical sensor 19 and/or an ECU 29 as described herein, but are not limited thereto. The constituent steps of the method depicted in FIG. 9 may be performed in any logical order, and the method is not limited to the sequence presented. Furthermore, steps of FIG. 9 may be combined and performed in a single step (or single action) without departing from the nature of the specification. Additionally, although certain steps or actions may be described in the singular form for the sake of clarity, it is to be understood that any of the steps of the method 900 may be repeated as necessary.

The method 900 initiates with step 905, which includes labelling points as retroreflector 27 points. To determine retroreflector 27 points the processor 31 initially generates a histogram 51 from an electrical signal produced by the receiver 49. The histogram 51 depicts the intensity of reflected beams 25 as photon counts over time. Curves 57 are generated by the processor 31 that bound portions of the histogram 51 corresponding to the detected reflected beams 25. Each curve 57 is generated based upon the peak amplitude 53 of the pulse as well as the FWHM start 61 and FWHM end 63 as derived from the half amplitude line 55.

Once the curves 57 are generated on the histogram 51, the area of each curve 57 is determined using various mathematical processes discussed above in relation to FIG. 3. The determined area values are stored in an area image table 93 as depicted in FIG. 5. The processor 31 proceeds to compare the points contained in the area image table 93 to a retroreflector threshold 59. The retroreflector threshold 59 is determined using a linear SVM algorithm as described above. Area values that eclipse the retroreflector threshold 59 are classified as retroreflector 27 points, and area values less than the retroreflector threshold 59 are classified as non-retroreflector points.

After determining which points exceed the retroreflector threshold 59 the method proceeds to step 910. Step 910 involves grouping adjacent retroreflector 27 points to form a series of retroreflector points 95. During this step the processor 31 determines that each retroreflector 27 point is adjacent to at least two other retroreflector 27 points. Two or more (or, in alternative embodiments, three or more) adjacent retroreflector 27 points are grouped and classified as a series of retroreflector points 95. Points above the retroreflector threshold 59 but not adjacent to other points above the retroreflector threshold 59 are delisted (i.e., no longer considered to be) retroreflector 27 points by the processor 31. Once all of the series of retroreflector points 95 are determined, the method proceeds to step 915.

Step 915 includes determining points in a column (i.e., a slot 77) with a similar range value as the retroreflector 27 points. Range values are stored by the processor 31 in a range image table 97, and the range values are located in the same layers 75 and slots 77 as area values associated with a same reflected beam of the reflected beams 25. As noted above, the phrase “similar” in the context of a “similar range value” implies values within a predefined distance (e.g., within 5 centimeters) or a predefined percentage of a distance (e.g., within 5 percent of the maximum distance value of the evaluated range values) of a retroreflector 27 point as determined in step 905. Thus, determining similarity between retroreflector 27 points in step 915 includes evaluating retroreflector range values associated with the series of retroreflector points 95 for similarity. In the event that a point classified as a retroreflector 27 point in steps 905 and 910 is determined to have a dissimilar range value in step 915, then such a point is delisted as a retroreflector 27 point. Once the processor 31 determines that the retroreflector 27 points in the series of retroreflector points 95 have similar range values, and has delisted the dissimilar values, the method proceeds to step 920.

Step 920 is directed towards determining and outputting blooming points 81. Once the dissimilar retroreflector range values are delisted in step 915, the remaining area values associated with the series of retroreflector points 95 are compared to a blooming threshold. In juxtaposition to the retroreflector threshold 59, which is determined using a linear SVM algorithm and is thus a sloped threshold, the blooming threshold may be a single value that is greater than all values of the retroreflector threshold 59. The area values associated with the series of retroreflector points 95 are compared to the blooming threshold. Area values less than the blooming threshold are reclassified as potential blooming points 99, whereas values greater than the blooming threshold are maintained as retroreflector 27 points. The method 900 thus concludes with the identification of both blooming points 81 and retroreflector 27 points.

FIG. 10 depicts a flowchart of a method 1000 for determining retroreflector points. Steps of the flowchart shown in FIG. 10 may be performed by an optical sensor 19 and/or an ECU 29 as described herein, but are not limited thereto. The constituent steps of the method depicted in FIG. 10 may be performed in any logical order, and the method is not limited to the sequence presented. Furthermore, steps of FIG. 10 may be combined and performed in a single step (or single action) without departing from the nature of the specification. In addition, although certain steps or actions may be described in the singular form for the sake of clarity, it is to be understood that any of the steps of the method 1000 may be repeated as necessary.

The method 1000 initiates with step 1005, which includes projecting a plurality of incident beams 21 with an emitter 47. The emitter 47 may be practically embodied as a Vertical Cavity Surface Emitting Laser (VCSEL) or equivalent pulsed light emission device. The emitter 47 projects the incident beams 21 according to instructions issued by the processor 31, and the incident beams 21 are projected in 2-5 nanosecond bursts, for example. Once the emitter 47 projects the incident beams 21 the method 1000 proceeds to step 1010.

Step 1010 includes redirecting the incident beams 21 towards an external environment 13 with a mirror 43. The mirror 43 may be practically embodied as a tilt or nodding mirror. Functionally, the use of a mirror 43 allows the optical sensor 19 to disperse the incident beams 21 throughout the external environment 13 in order to generate a three dimensional representation of the external environment 13. That is, the use of a mirror 43 allows a single emitter 47 to project the incident beams 21 throughout the environment without the need to adjust the position of the emitter 47 itself.

In step 1015 the mirror 43 is rotated with a motor 45. The motor 45 may be configured as a servo motor or a micromotor in accordance with one or more embodiments disclosed herein. The shaft (not shown) of the motor 45 is affixed to the mirror 43, such that the rotation of the motor 45 causes the mirror 43 to rotate as well. As noted above, the rotation of the mirror 43 allows for the dispersion of incident beams 21 throughout the external environment 13. Thus, step 1015 concludes with incident beams 21 being redirected towards the external environment 13 by the mirror 43 as the mirror 43 is rotated by the motor 45.

Step 1020 includes receiving a plurality of reflected beams 25 with the receiver 49. The receiver 49 may be embodied as a SPAD array as discussed above. The reflected beams 25 are incident beams 21 that have been reflected by one or more objects in the external environment 13. Each reflected beam 25 has an associated intensity corresponding to the amount of photons reflected by the object. Such an object may include a retroreflector 27 as depicted in FIG. 1, which reflects the incident beams 21 as reflected beams 25 with minimal scattering. Once the reflected beams 25 are detected by the receiver 49 the method proceeds to step 1025.

Step 1025 includes generating an electrical signal with the receiver 49. The electrical signal corresponds to the amount of photons detected by the receiver 49. The electrical signal is generated in real-time. In one or more embodiments, the magnitude of the electrical signal may correspond directly or substantially correspond to the amount of detected photons. The electrical signal thus represents a data output of the receiver 49 corresponding to the presence of detected photons. The detected photons may be photons included in a reflected beam 25 or photons detected as ambient light from the external environment 13.

Step 1030 includes receiving the electrical signal from the receiver 49 with a processor 31. The electrical signal is generated in step 1025, above, and is transmitted from the receiver 49 to the processor 31 using a data connection 35 in embodiments where the optical sensor 19 comprises a stand-alone device. In other embodiments where the optical sensor 19 relies on the ECU 29 for processing LiDAR data the electrical signal is transmitted from the emitter 47 to the processor 31 of the ECU 29 by way of data connections 35, data ports 37, and a wiring harness 39.

Step 1035 includes generating a histogram 51 including a time-series data plot of the electrical signal with the processor 31. The histogram 51 depicts the intensity of reflected beams 25 as photon counts over time. More specifically, the histogram 51 depicts light pulses in a time-series fashion, where each pulse (i.e., a bell shaped portion of the histogram 51) corresponds to the photons detected from one reflected beam 25. Once the histogram 51 is generated the method 1000 proceeds to step 1040.

In step 1040 a plurality of curves 57 are generated on the histogram 51. The curve 57 are generated by the processor 31. Each curve 57 delimits a portion of a histogram 51 associated with one of the detected reflected beams 25. The curves 57 are generated based upon the peak amplitude 53 of the pulse as well as the FWHM start 61 and FWHM end 63 of the pulse as derived using the half amplitude line 55. Once the curves 57 are identified the method 1000 proceeds to step 1045.

Step 1045 includes determining an area value for each curve 57. Each area value denotes an area of the histogram 51 beneath an associated curve 57 such that the area values approximate the area of the pulse itself. Determining the area of a particular curve 57 may include performing simple trigonometric computations (i.e., discretizing a curve 57 into common geometric shapes and summing the individual areas to form an area value of the curve 57), or more advanced mathematical processes such as integration. Once the area values are determined in step 1045 the method proceeds to step 1050.

Step 1050 includes generating an area image table 93 including the area values generated in step 1045. Each cell of the area image table 93 contains an area value derived from a particular curve 57 as described in step 1045. The area image table 93 is generated by the processor 31 and stored on the memory 33. The area image table 93 is formed of layers 75 (i.e., rows) and slots 77 (i.e., columns), and has the same or similar dimensions as an image (i.e., an intensity image 79) captured by the receiver 49 and generated by the processor 31. Each cell of the area image table 93 thus has a layer 75 and slot 77 location corresponding to the location of a portion of an object that reflects the corresponding incident beam 21 in the external environment 13.

Step 1055 includes classifying each of the area values that exceeds a first threshold as retroreflector 27 points. The first threshold is a retroreflector threshold 59 determined and generated by the processor 31 using a linear Support Vector Machine (SVM) algorithm. Area values that exceed the retroreflector threshold 59 are classified as retroreflector 27 points and area values less than the retroreflector threshold 59 are classified as non-retroreflector points. Once the retroreflector 27 points are determined the method proceeds to step 1060.

Step 1060 includes storing the retroreflector 27 points and the histogram 51. The retroreflector 27 points are contained in the area image table 93. Step 1060 thus includes storing the area image table 93 and the histogram 51 on a memory 33. The memory 33 comprises a non-transient storage medium such as a Hard Disk Drive (HDD), a Solid State Drive (SSD), or equivalent storage devices. The method 1000 concludes once the area image table 93 and the histogram 51 are stored on the memory 33. After the conclusion of the method 1000, the area image table 93 may be retrieved by the processor 31 from the memory 33 to determine blooming points 81 as described in the method 900 of FIG. 9. The processor 31 may also generate an area image (not shown) or a modified area image (not shown) based upon the area image table 93 as discussed above. Thus, the identification and storage of retroreflector points in the area image table 93 aids in controlling the vehicle 11 in environments where numerous retroreflectors 27 are present.

Although only a few example embodiments have been described in detail above, those skilled in the art will readily appreciate that many modifications are possible in the example embodiments without materially departing from this invention. For example, one or more alternative embodiments may include an emitter 47 embodied as an Electro-absorption Modulated Laser (EML) or other laser diode instead of a VCSEL. Similarly, the receiver 49 may be embodied as a Silicon Photomultiplier (SiPM) array instead of the SPAD array discussed above. Furthermore, the retroreflector threshold may be a static value instead of being determined using a linear SVM algorithm, or be a linear threshold determined by an operator or manufacturer of the optical sensor and/or ECU. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed is:

1. A vehicle device comprising:
an emitter configured to project a plurality of incident beams that are reflected, as a plurality of reflected beams, by at least one object disposed in an external environment of the emitter;
a mirror configured to redirect the plurality of incident beams towards the external environment;
a motor configured to rotate the mirror, thereby adjusting an exit angle of the plurality of incident beams relative to a horizontal axis;
a receiver configured to receive the plurality of reflected beams and generate an electrical signal that corresponds to a received strength of the plurality of reflected beams;
a processor configured to:
receive the electrical signal from the receiver and generate a histogram comprising a time-series data plot of the electrical signal such that the histogram depicts the electrical signal as a series of pulses;
generate a plurality of curves that bound portions of the histogram, where each curve is associated with a corresponding pulse of the series of pulses;
determine, for each curve of the plurality of curves, an area value correlating to an area of the histogram delimited by an associated curve of the plurality of curves, thereby producing a plurality of area values each associated with the corresponding pulse;
generate an area table comprising the plurality of area values; and
classify each of the plurality of area values that exceeds a retroreflector threshold as a retroreflector point, thereby producing retroreflector points; and
a non-transient storage medium configured to store the histogram and the retroreflector points.

2. The vehicle device of claim 1, wherein each retroreflector point is adjacent to at least one other retroreflector point located in a same column of the area table.

3. The vehicle device of claim 1, wherein the receiver is configured to detect an amount of ambient light present in the external environment and generate a plurality of ambient light values corresponding to the amount of ambient light.

4. The vehicle device of claim 3, wherein the processor is further configured to generate an ambient light table comprising the plurality of ambient light values.

5. The vehicle device of claim 1, wherein the processor is further configured to generate a range table comprising a plurality of range values, where each range value is derived from a time of flight of the corresponding pulse and is associated with one area value of the plurality of area values.

6. The vehicle device of claim 5, wherein the processor is further configured to determine whether each of the range values associated with the retroreflector points are within a predetermined range threshold from at least one adjacent range value also associated with the retroreflector points, and classify the range values within the predetermined range threshold as retroreflector range values.

7. The vehicle device of claim 6, wherein the processor is further configured to compare the area values associated with the retroreflector range values to a blooming threshold, and classify the area values that are less than the blooming threshold as blooming points.

8. The vehicle device of claim 7, wherein the processor is configured to generate an output image comprising blooming labels denoting the blooming points and retroreflector labels denoting the retroreflector points.

9. The vehicle device of claim 1, wherein each curve is delimited by a Full Width at Half Maximum (FWHM) start and a FWHM end.

10. The vehicle device of claim 1, wherein each curve is delimited by a peak intensity of the corresponding pulse.

11. The vehicle device of claim 1, wherein the processor is configured to determine the retroreflector threshold using a linear Support Vector Machine (SVM) algorithm.

12. The vehicle device of claim 1, wherein the receiver comprises a Single Photon Avalanche Diode (SPAD) array or an Avalanche PhotoDiode (APD) array.

13. A method comprising:
projecting a plurality of incident beams with an emitter;
redirecting the plurality of incident beams with a mirror towards an external environment of the emitter;
rotating the mirror with a motor, thereby adjusting an exit angle of the plurality of incident beams relative to a horizontal axis;
receiving a plurality of reflected beams with a receiver, where the plurality of incident beams are reflected, as the plurality of reflected beams, by at least one object disposed in the external environment;
generating an electrical signal with the receiver, where the electrical signal corresponds to a received strength of the plurality of reflected beams;
receiving the electrical signal from the receiver with a processor;
generating a histogram with the processor, where the histogram comprises a time-series data plot of the electrical signal such that the histogram depicts the electrical signal as a series of pulses;
generating a plurality of curves that bound portions of the histogram with the processor, where each curve is associated with a corresponding pulse of the series of pulses;
determining, for each curve of the plurality of curves, an area value correlating to an area of the histogram delimited by an associated curve of the plurality of curves, thereby producing a plurality of area values, with the processor, that are each associated with the corresponding pulse;
generating an area table comprising the plurality of area values with the processor;
classifying each of the plurality of area values that exceeds a retroreflector threshold as retroreflector points with the processor; and
storing the histogram and the retroreflector points with a non-transient storage medium.

14. The method of claim 13, wherein each retroreflector point is adjacent to at least one other retroreflector point located in a same column of the area table.

15. The method of claim 13, further comprising: detecting an amount of ambient light present in the external environment and generating a plurality of ambient light values corresponding to the amount of ambient light with the receiver.

16. The method of claim 15, further comprising: generating an ambient light table comprising the plurality of ambient light values with the processor.

17. The method of claim 13, further comprising: generating a range table comprising a plurality of range values with the processor, where each range value is derived from a time of flight of the corresponding pulse.

18. The method of claim 17, further comprising: determining retroreflector range values that have a similar range value as the retroreflector points, and classifying the retroreflector range values having area values less than a blooming threshold as blooming points, with the processor.

19. The method of claim 18, further comprising: generating an output image with the processor comprising blooming labels denoting the blooming points and retroreflector labels denoting the retroreflector points not associated with the blooming points.

20. A system comprising:
an optical sensor comprising:
an emitter configured to project a plurality of incident beams that are reflected, as a plurality of reflected beams, by at least one object disposed in an external environment of the emitter;
a mirror configured to redirect the plurality of incident beams towards the external environment;
a motor configured to rotate the mirror, thereby adjusting an exit angle of the plurality of incident beams relative to a horizontal axis; and
a receiver configured to receive the plurality of reflected beams and generate an electrical signal that corresponds to a received strength of the plurality of reflected beams; and
an Electronic Control Unit (ECU) comprising:
a processor configured to:
receive the electrical signal from the optical sensor and generate a histogram comprising a time-series data plot of the electrical signal such that the histogram depicts the electrical signal as a series of pulses;
generate a plurality of curves that bound portions of the histogram, where each curve is associated with a corresponding pulse of the series of pulses;
determine, for each curve of the plurality of curves, an area value correlating to an area of the histogram delimited by an associated curve of the plurality of curves, thereby producing a plurality of area values each associated with the corresponding pulse;
generate an area table comprising the plurality of area values; and
classify each of the plurality of area values that exceeds a retroreflector threshold as retroreflector points; and
a non-transient storage medium configured to store the histogram and the retroreflector points.
